(19) United States
(12) Patent Application Publication
(10) Pub. No.: US 2024/0354635 A1
(43) Pub. Date: Oct. 24, 2024

(54) MACHINE LEARNING TECHNIQUES FOR INFERRING TRANSIT TIMES AND MODES FOR SHIPMENTS

(71) Applicant: PROJECT44, LLC, Chicago, IL (US)

(72) Inventors: Milad Davaloo, Oakland, CA (US); Thomas Janos Atwood, Venice, CA (US); Matthew George Dzugan, Forest Park, IL (US); Venkata Sravan Kumar Kanukolanu, Fremont, CA (US); Asha Anju, Los Altos, CA (US); James Laurence McElveen, Shiloh, IL (US)

(21) Appl. No.: 18/136,285

(22) Filed: Apr. 18, 2023

(51) Int. Cl. G06N 20/00

(52) U.S. Cl. CPC G06N 20/00

(57) ABSTRACT

A computer-implemented method includes constructing a plurality of nodes; adding the nodes to a graph; receiving origin, destination and shipment parameters; and processing the parameters to determine target outcomes corresponding to a cargo shipment. A computing system includes a processor; and a memory having stored thereon computer-executable instructions that, when executed by the processor, cause the computing system to: construct a plurality of nodes; add the nodes to a graph; receive origin, destination and shipment parameters; and process the parameters to determine target outcomes corresponding to a cargo shipment. A computer-readable medium includes instructions that, when executed by a processor, cause a computer to: constructing a plurality of nodes construct a plurality of nodes; add the nodes to a graph; receive origin, destination and shipment parameters; and process the parameters to determine target outcomes corresponding to a cargo shipment. The target outcomes may include time, emissions and/or costs.

### FIELD

The present disclosure is directed to improvements related to predicting information related to multimodal shipping, and more particularly, to platforms and technologies for processing historical transit data to train one or more machine learning models.

### BACKGROUND

In the context of commercial shipping, predicting when a shipment will arrive at a destination is one-hop oriented, focusing on estimates of time from one point to another via a single mode of transportation (e.g., via truck). Modeling more complex scenarios is not a well-understood problem. For example, an item may be manufactured in Vietnam, loaded onto a truck, offloaded from the truck, loaded onto an ocean vessel, offloaded from the ocean vessel, loaded onto a train, offloaded from the train, loaded onto a truck, and finally offloaded from the truck at a final destination.

This type of shipping, involving multiple modes of transportation, is referred to in the industry as multi-modal transportation, and generally refers to the use of multiple modes of transportation, such as ships, trucks, trains, and planes to transport goods from one place to another. This type of transportation allows for greater flexibility and efficiency in the shipping process, as different modes can be utilized based on factors such as cost, speed, and the type of goods being transported.

For example, goods may be transported by ship over long distances, and then transferred to trains or trucks for delivery to their final destination. By using multiple modes of transportation, companies can take advantage of the strengths of each mode, reducing the costs and transit times associated with shipping goods, and improving the overall efficiency of the transportation system.

However, multi-modal shipping can be difficult to optimize in the context of commercial shipping due to several factors. For example, coordinating multiple modes of transportation can be complex, as each mode has its own scheduling, routing, and transportation requirements. This can lead to challenges in ensuring that goods are transported efficiently and effectively from one mode to another.

Further, the availability and cost of each mode of transportation can vary, making it difficult to plan and optimize multi-modal shipping in advance. Additionally, unexpected disruptions, such as weather events or equipment failures, can impact the transportation system and make it difficult to maintain optimal shipping schedules.

An additional complication is that some modal segments are “schedule based” and others are more or less “on demand.” For the sake of this disclosure nuances related to complying with known schedules are not included.

Moreover, while multi-modal shipping can be more cost-effective than using a single mode of transportation, it can be difficult to determine the optimal combination of modes that provides the best balance of cost and transit time. This is further complicated by the fact that the cost of each mode of transportation can change over time.

Still further, integrating different modes of transportation can be a challenge, as each mode has its own technology systems and processes. Ensuring that these systems and processes work seamlessly together can be difficult and time-consuming.

Conventional systems for facilitating multimodal transportation are inadequate. Such systems include Transportation Management Systems (TMSs), route optimization algorithms, and real-time data analysis. TMSs are software systems that are used to plan, execute, and monitor multi-modal shipments. These systems typically provide real-time visibility into shipments, allowing shippers to make informed decisions about routing and mode selection. Route optimization algorithms use mathematical models to determine the optimal combination of modes and routes for a given shipment. These algorithms consider factors such as cost, transit time, and available capacity to determine the best shipping plan. Real-time data analysis involves the use of data from various sources, such as GPS tracking and shipping logs, to monitor and optimize multi-modal shipments in real-time. This data can be used to detect potential disruptions, such as weather events or equipment failures, and to make adjustments to shipping plans as needed.

However, there are several problems with conventional multimodal transportation systems. For example, these systems are built on a set of known/knowable segments. However, in practice, routes (e.g., train routes) are often unknown. A transportation company may only have limited information, for example that 1) a shipment is being picked up in Asia and 2) delivered to a location in North America. The gaps between this shipment may be unknown, leaving the company with no idea how long it will take for the shipment to arrive. Thus, conventional systems do not allow for estimations in the presence of missing data.

Another issue is cost. Implementing and maintaining TMSs, route optimization algorithms, and real-time data analysis systems can be expensive, and may require significant upfront investments. Another is data quality. The accuracy of the data used to optimize multi-modal shipping is critical, and poor data quality can lead to suboptimal shipping plans. This can be a challenge in some cases, as the data used in these systems may be incomplete or inaccurate. Yet another is complexity. The complexity of these techniques can make them difficult to implement and use, particularly for smaller companies with limited resources. And a final issue is inflexibility. These techniques are designed to optimize multi-modal shipping for a specific set of conditions and may not be able to accommodate unexpected changes or disruptions.

Accordingly, there is an opportunity for platforms and technologies to leverage data sources and data analysis techniques to improve multimodal shipping in several ways, including by lowering complexity, increasing certainty, lowering costs, easing integration, improving data quality and/or increasing flexibility.

### SUMMARY

In an embodiment, a computer-implemented method of using machine learning to construct and train a graph to predict target outcomes corresponding to a cargo shipment includes: (i) constructing, via one or more processors, a plurality of location nodes, wherein each of the location nodes corresponds to a respective location type, wherein each of the location nodes corresponds to a respective real-world location, and wherein each of the location nodes includes a mode input, a dray input, a mode output, and a dray output; (ii) adding, via one or more processors, the plurality of location nodes to the graph; (iii) receiving, via one or more processors, an origin input parameter, a destination input parameter, and one or more shipment events corresponding to the cargo shipment; and (iv) processing, via one or more processors, the shipment events using the graph to determine one or more target outcomes corresponding to the cargo shipment.

In another embodiment, a computing system for using machine learning to construct and train a graph to predict target outcomes corresponding to a cargo shipment includes one or more processors; and one or more memories having stored thereon computer-executable instructions that, when executed by the one or more processors, cause the computing system to: (i) construct a plurality of location nodes, wherein each of the location nodes corresponds to a respective location type, wherein each of the location nodes corresponds to a respective real-world location, and wherein each of the location nodes includes a mode input, a dray input, a mode output, and a dray output; (ii) add the plurality of location nodes to the graph; (iii) receive an origin input parameter, a destination input parameter, and one or more shipment events corresponding to the cargo shipment; and (iv) process, via one or more processors, the shipment events using the graph to determine one or more target outcomes corresponding to the cargo shipment.

Further, a computer-readable medium having stored thereon a set of instructions that, when executed by one or more processors, cause a computer to: (i) construct a plurality of location nodes, wherein each of the location nodes corresponds to a respective location type, wherein each of the location nodes corresponds to a respective real-world location, and wherein each of the location nodes includes a mode input, a dray input, a mode output, and a dray output; (ii) add the plurality of location nodes to the graph; (iii) receive an origin input parameter, a destination input parameter, and one or more shipment events corresponding to the cargo shipment; and (iv) process, via one or more processors, the shipment events using the graph to determine one or more target outcomes corresponding to the cargo shipment.

### BRIEF DESCRIPTION OF THE FIGURES

FIG. 1 illustrates an overview of a computing system, according to some aspects.

FIG. 2 depicts an exemplary global shipping map, according to some aspects of the present techniques.

FIG. 3A depicts an exemplary graph representing a node of a facility at a location, according to some aspects.

FIG. 3B depicts an exemplary graph depicting multiple modes of transportation represented as multiple subgraphs, according to some aspects.

FIG. 4A depicts a diagram of the shipment routes and known locations of the global shipping map of FIG. 2, according to some aspects.

FIG. 4B depicts a graph of all of potential connections (edges) between locations in the global shipping map, according to some aspects.

FIG. 4C depicts a graph that includes a plurality of location nodes and a plurality of transit edges, according to some aspects.

FIG. 4D depicts an example of adding truckload modeling to the graph of FIG. 4C, according to some aspects.

FIG. 5 depicts a block diagram of an example method of using machine learning to construct and train a graph to predict target outcomes corresponding to a cargo shipment, according to some aspects.

### DETAILED DESCRIPTION

The present aspects may relate to, inter alia, predicting information related to multimodal shipping, and more particularly, to platforms and technologies for processing historical transit data to train one more machine learning models.

As noted, international shipments typically involve more than one mode of transportation (ocean, rail, air, truckload, etc.). The present techniques may include methods and systems for predicting an end-to-end estimated time of arrival (ETA) across all possible shipment modes using a trained multimodal transit graph.

The present techniques may include training the multimodal transit graph on historical transit and dwell times for each mode independently, stitching the different modes together via intermodal transfer information observed historically.

The trained multimodal transit graph may be traversed by solving for the shortest path, minimizing a custom metric that combines transit times with likelihood to traverse each edge of the graph.

In some aspects, the trained multimodal transit graph takes as input any known locations (start, end, as well as any known waypoints), modes, and carriers for the shipment, and provides an ETA at the final delivery destination, as well as granular transit and dwell estimates for all segments along the shipment's journey.

The systems and methods therefore offer numerous benefits. In particular, the systems and methods use machine learning or artificial intelligence techniques to determine transit times effectively and accurately for multi-modal shipments, while accounting for delays due to transitioning between modes and other contingencies.

By enabling the user to selectively model potential transit routes based on optimization parameters/constraints, as discussed below (referred to herein as “outcomes” or “target outcomes”), the present techniques enable the multi-modal transit systems to not only be more cost-effective and provide goods to customers more quickly, but also to reduce emissions, thereby improving fuel efficiencies and lessening environmental impacts.

Still further, the present techniques may leverage historical data to gap-fill opaque datasets surrounding global shipping. For example, as discussed below, historical modeling may be used to predict which carrier(s) serve certain transit routes, to estimate dwell times based on historical dwell/transit events, etc. This capability is especially powerful in the present techniques, wherein all segments of a journey can be analyzed to determine historical estimates of an entire route involving multiple modes of transportation.

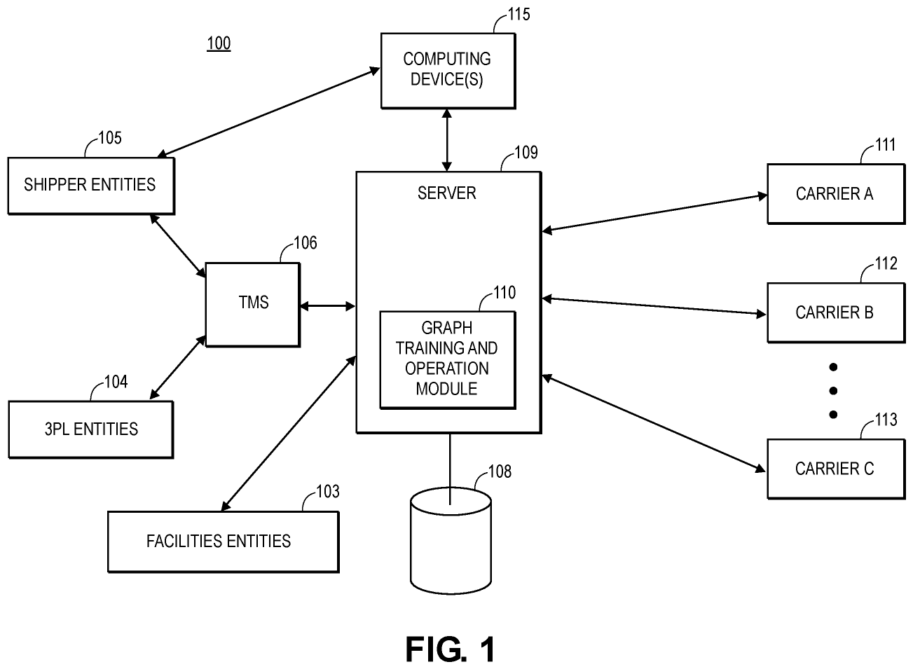

FIG. 1 illustrates an overview of a system 100 of components configured to facilitate the systems and methods, according to some aspects. It should be appreciated that the system 100 is merely exemplary and that alternative or additional components are envisioned.

As illustrated in FIG. 1, the system 100 includes a set of facilities entities 103, a set of shipper entities 105 and a set of 3PL entities 104.

Each of the facilities entities 103 may be a company, corporation, business, entity, individual, group of individuals and/or the like that may own, operate and/or manage a facility (e.g., a shipment origin and/or destination, whether intermediate or final). A “facility,” “location” or “waypoint” herein may refer to any physical space through which goods transit and/or are stored even if only temporarily during the shipment of goods, such as a warehouse, a retail store, a distribution center, a storage facility, a parking lot, a dock, a port, an airport, a train yard, a terminal, a weighing station, etc.

Each of the set of shipper entities 105 may be a company, corporation, business, entity, individual, group of individuals, and/or the like that may manufacture, supply, or otherwise have access to physical goods, supplies, materials, animals, and/or other items (generally, “physical goods”) capable of being physically transported. Generally, each of the set of shipper entities 105 may intend to have transported a set of physical goods from an origin location to a destination location, where the set of physical goods may have an associated weight, dimensions, and/or other parameters. It should be appreciated that various amounts of the shipper entities 105 are envisioned. It should also be appreciated that in some instances, the shipper entities 105 may be facilities entities 103, and vice versa.

Each of the 3PL entities 104 may be a third-party provider that the set of shipper entities 105 may use to outsource certain elements associated with handling and managing the transportation of the physical goods. In some aspects, one or more of the shipper entities 105 may include one or more of the 3PL entities 104 (or vice versa). The set of 3PL entities 104 may manage the fulfillment of shipping requests that originate from the set of shipper entities 105. Generally, each of the set of 3PL entities 104 may manage operation, warehousing, and transportation services which may be scaled and customized to customers' needs based on certain market conditions, such as the demands and delivery requirements for products and materials, and may manage one or more particular functions within supply management, such as warehousing, transportation, or raw material provision. Each of the set of 3PL entities 104 may be a single service or may be a system-wide bundle of services capable of managing various aspects of a supply chain (e.g., transportation of physical goods). It should be appreciated that various amounts of the 3PL entities 104 are envisioned.

The system 100 may further include a set of carrier entities (as shown: carrier A 111, carrier B 112, and carrier C 113). Each of the carrier entities 111, 112, 113 may be a company, corporation, business, entity, individual, group of individuals, and/or the like that owns or otherwise has access to a set of vehicles capable of transporting physical goods. According to aspects, the transportation of goods may be accomplished via marine or water (i.e., using vessels, boats or ships), air (i.e., using aircraft), rail (i.e., using trains), or road (i.e., using trucks, cars, or other land-based vehicles). The term “vehicle,” as used herein, may refer to any vessel or craft capable of transporting goods via marine or water, air, rail, and/or road. The shipments of the goods may be categorized differently. Generally, freight shipments may be specific to trucks and may be categorized as less than truckload (LTL) or truckload (TL). Typically, but not always, LTL shipments may range from fifty (50) to 7,000 kg in weight and 2.5 to 8.5 m in dimension, where trailers used in LTL shipments may range from 8.5 to 16.5 m, and where the shipments may be palletized, shrink-wrapped, and packaged. TL shipments are typically, but not always, larger than 7,000 kg, and may consist of physical goods that may be shipped using a single loaded truck.

The set of shipper entities 105 and the set of 3PL entities 104 may interface and communicate with a transportation management system (TMS) 106. According to aspects, the TMS 106 may be any of a general transportation management system, warehouse management system (WMS), order management system (OMS), enterprise resource planning (ERP) system, or otherwise a system that may be used to manage freight. Generally, the TMS 106 may at least partly facilitate shipping agreements between the set of shipper entities 105 and the set of carrier entities 111, 112, 113, where the TMS 106 may facilitate route planning and optimization, load optimization, execution, freight audit and payment, yard management, advanced shipping, order visibility, and carrier management. The TMS 106 may be an open-source system or may be proprietary to any of the set of shipper entities 105 or the set of 3PL entities 104. According to aspects, the TMS 106 may support specific and particular communication capabilities with the other entities of the system 100. In particular, the TMS 106 may support communication with the other entities via different components and protocols.

As illustrated in FIG. 1, the system 100 may include a server 109 that may interface and communicate with at least the TMS 106, the set of carrier entities 111, 112, 113, and a set of computing devices 115. The server 109 may include any combination or hardware and software components and may be associated with any type of entity or individual. The server 109 may support execution of a graph training and operation module 110. According to aspects, the graph training and operation module 110 may construct one or more graphs, as discussed herein.

The graph training and operation module 110 may add one or more respective nodes and one or more respective edges to the one or more graphs. The graph training and operation module 110 may include sets of computer-executable instructions implementing one or more graph traversal/optimization algorithm (e.g., a modified Dijkstra's algorithm, a modified Prim's algorithm, a modified breadth-first search (BFS) algorithm, a modified depth-first search (DFS) algorithm, etc.). The graph training and operation module 110 may receive various data associated with a shipment (e.g., event data, historical data, etc.) and construct a graph or modify an existing graph based on that data. In some aspects, the graph training and operation module 110 may construct nodes dynamically based on certain received data, as discussed below with respect to truckload modeling.

In some aspects, the server 109 may include a set of instructions implementing machine learning model training. For example, the instructions may implement training and/or operation of a supervised machine learning model (e.g., an artificial neural network, a deep learning model, etc.) for predicting information based on historical information. Further examples are discussed below.

The graph training and operation module 110 may interface with a database 108 or other type of memory configured to store data accessible by the graph training and operation module 110.

The set of computing devices 115 may enable users access to a dashboard, interface, or the like that may include parameters of various shipping data, as determined by the graph training and operation module 110. For example, the user may access one or more dashboards that enable the user to estimate shipping times for shipments from various origins to various destinations, and to optionally select one or more optimization parameters/constraints, as discussed below. In aspects, the set of computing devices 115 may be associated with one or more of the shipper entities 105. Accordingly, the set of computing devices 115 may interface with the server 109 and/or the shipper entities 105.

Although FIG. 1 depicts the server 109 in communication with the TMS 106 and the set of carrier entities 111, 112, 113, it should be appreciated that alternative configurations are envisioned. In one particular implementation, the TMS 106, the 3PL entity 104, and the server 109 may be combined as a single entity (i.e., the server 109 may communicate directly with the shipper entities 105, the facilities entities 103 and/or the set of carrier entities 111, 112, 113). In another implementation, either the TMS 106 or the 3PL entity 104 may be combined with the server 109 as a single entity capable of performing the respective functionalities.

Although not depicted in FIG. 1, the server 109 may support one or more computer networks that may enable communication between and among the entities and components of the server 109. In aspects, the computer network(s) may support any type of wired or wireless data communication via any standard or technology (e.g., GSM, CDMA, TDMA, WCDMA, LTE, EDGE, OFDM, GPRS, EV-DO, UWB, Internet, IEEE 802 including Ethernet, WiMAX, Wi-Fi, Bluetooth, and others). For example, the set of shipper entities 105 and the computing device(s) 115 may communicate with the TMS 106 (and/or with the module 110) via an Internet connection.

Generally, a shipper entity 105 ships one or more shipments using one of the carriers 111-113. Along the way, the shipment may visit one or more facilities of the facilities entities 103. The shipper, carriers and/or facilities entities may contract with one another to facilitate the loading, transportation, storage and/or unloading of freight or other goods.

It should be appreciated that the components and entities of the server 109 may include and support various combinations of hardware and software components capable of facilitating various of the functionalities of the systems and methods. For example, the components and entities of the server 109 may generally support one or more computer processors, communication modules (e.g., transceivers), memories, and/or other components.

The system 100 may be implemented on any computing device or combination of computing devices, including the server 109. Components of computing device(s) may include, but are not limited to, a processing unit (e.g., one or more processors), a system memory, and a system bus that couples various system components including the memory to the processor(s). In some aspects, the processor(s) may include one or more parallel processing units capable of processing data in parallel with one another. The system bus may be any of several types of bus structures including a memory bus or memory controller, a peripheral bus, or a local bus, and may use any suitable bus architecture. By way of example, and not limitation, such architectures include the Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus (also known as Mezzanine bus).

In some aspects, the system 100 may further include one or more a user interfaces configured to present content (e.g., input data, output data, processing data, and/or other information). Additionally, a user may simulate/estimate shipping based on user-provided input parameters, as discussed below, and view interactive maps. The user may view estimates of shipping times for proposed shipping routes, and select optimization parameters/constraints (e.g., from one or more dropdown menus, by selecting radio inputs, etc.) via a user interface, such as a mobile device, a web browser in a client computing device such as the device 115, etc.

The one or more user interfaces may be embodied as part of a touchscreen configured to sense touch interactions and gestures by the user. Although not shown, other system components communicatively coupled to the system bus may include input devices such as cursor control device (e.g., a mouse, trackball, touch pad, etc.) and keyboard (not shown). A monitor or other type of display device may also be connected to the system bus via an interface, such as a video interface. In addition to the monitor, computers may also include other peripheral output devices such as a printer, which may be connected through an output peripheral interface (not shown).

The memory may include a variety of computer-readable media. Computer-readable media may be any available media that can be accessed by the computing device and may include both volatile and nonvolatile media, and both removable and non-removable media. By way of non-limiting example, computer-readable media may comprise computer storage media, which may include volatile and nonvolatile, removable and non-removable media implemented in any method or technology for storage of information such as computer-readable instructions, routines, applications (e.g., a shipping data processing application) data structures, program modules or other data. Computer storage media may include, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the processor of the computing devices.

The server 109 may operate in a networked environment and communicate with one or more remote platforms, such as an API (not depicted), via an electronic network(s), such as a local area network (LAN), a wide area network (WAN), or other suitable network(s). The system 100 may be implemented on any computing device(s) In some aspects, one or more applications as will be further described herein may be stored and executed remote from the server 109.

Generally, data input into and output from the server 109 may be embodied as any type of electronic document, file, template, etc., that may include various graphical/visual and/or textual content, and may be stored in memory as program data in a hard disk drive, magnetic disk and/or optical disk drive in the server and/or in remote computing devices. The server 109 may support one or more techniques, algorithms, or the like for analyzing input data to generate output data. In particular, the graph training and operation module 110 may process various types and forms of raw shipment data and other parameters associated with a shipment of goods to construct one or more graphs, and to operate one or more graph optimization algorithms on the one or more constructed graphs via one or more computer processors to determine one or more target outcomes corresponding to cargo shipments.

Based on the analysis, the graph training and operation module 110 may output data relating to the target outcomes (e.g., an estimated fastest arrival time, an estimated shortest path, an estimated lowest cost, an estimated lowest emissions, etc.) related to a given shipment. The graph training and operation module 110 may also output one or more routes (e.g., one or more nodes and/or edges of the graph) in conjunction with target outcomes, for example in a graphical user interface. Additionally, the graph training and operation module 110 may store the results of graph and/or ML modeling and other data that the server 109 generates or uses.

According to aspects, graph training and operation module 110 may employ graph optimization, graph search/traversal, machine learning and artificial intelligence techniques such as, for example, a regression analysis (e.g., a logistic regression, linear regression, random forest regression, probit regression, or polynomial regression), classification analysis, k-nearest neighbors, decisions trees, random forests, boosting, neural networks, support vector machines, deep learning, reinforcement learning, Bayesian networks, or the like. When the input data is a training dataset, the graph training and operation module 110 analyze/process the input data to generate a machine learning model(s) for storage as part of model data that may be stored in the memory of the server and/or in the database 180. The constructed graphs and their nodes/edges (including dynamically-constructed nodes/edges) may be stored in the server 109 memory and/or database 180.

When the input data comprises various tracking, inventory, and/or shipping raw data associated with a shipment to be processed using the graph optimization and/or trained machine learning models, the graph training and operation module 110 may analyze or process the input data using the constructed graphs and/or trained machine learning model to generate one or more target outcomes, (e.g., a net transit time of the cargo shipment, a net transit cost of the cargo shipment, a net emissions measure of the cargo shipment, etc.).

Event information processed by the graph optimization algorithms may include transit events, a dwell events, dray events, or any other events suitable for modeling in the present techniques. In some aspects, a graph optimization algorithm may use a machine learning model during graph optimization. For example, the graph optimization algorithm may use a supervised machine learning model to predict the identity of a carrier for a given edge connecting two nodes (i.e., for a transit segment connecting an origin and a destination). Another example is for predicting the historical dwell time of a given location node based on historical dwell time figures. It will be appreciated that the present machine learning techniques may be used to model many aspects of global shipping, beyond the examples aspects provided herein.

The module 110 (or another component) may cause the output data (and, in some cases, the training or input data) to be displayed on one or more user interfaces for review by the user of the server 109.

In general, a computer program product in accordance with an aspect may include a computer usable storage medium (e.g., standard random access memory (RAM), an optical disc, a universal serial bus (USB) drive, or the like) having computer-readable program code embodied therein, wherein the computer-readable program code may be adapted to be executed by the processor(s) (e.g., working in connection with an operating systems) to facilitate the functions as described herein. In this regard, the program code may be implemented in any desired language, and may be implemented as machine code, assembly code, byte code, interpretable source code or the like (e.g., via Golang, Python, Scala, C, C++, Java, ActionScript, Objective-C, JavaScript, CSS, XML, R, Stata, AI libraries). In some aspects, the computer program product may be part of a cloud network of resources. In some aspects, machine learning frameworks may be used to accelerate development and testing of the machine learning models (e.g., scikit-learn, hugging face, spaCy, TensorFlow, etc.). Further, graphing frameworks/tools may be used to construct/manipulate graphs (e.g., NetworkX, igraph, graph-tool, Graph Modeling Language (GML), etc.).

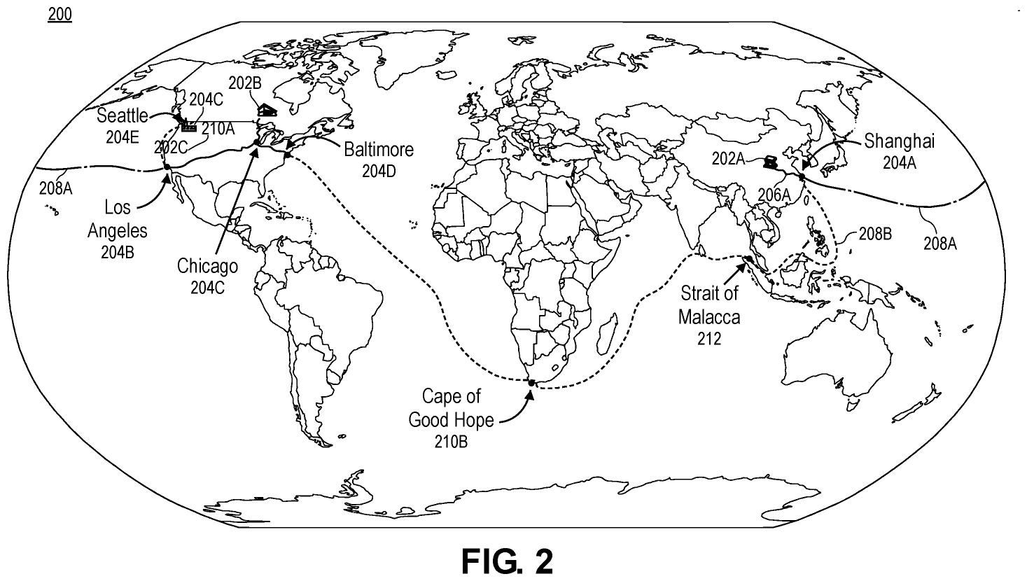

FIG. 2 depicts an exemplary global shipping map 200, according to some aspects of the present techniques. The map 200 includes an origin 202A (e.g., a factory), a destination 202B (e.g., a warehouse) and a destination 202C (e.g., an airport). The origin 202A is connected to a port 204A by a road 206A. The port 204A is connected to a port 204B by a shipping lane 208A, and to a port 204C by a shipping lane 208B. The port 204B may be connected to a port 204C via air and to a port 204D via a rail line 210A.

Any of the origins 202 may be any suitable location, such as a factory, a warehouse, a distribution center, a retail store, a manufacturing facility, a private home, a business, etc. Any of the ports 204 may include suitable port(s), such as a seaport, an airport, a rail port, etc. In some instances, the ports 204 may be combined, or hybrid, locations (e.g., a seaport that includes or is geographically adjacent to rail facilities).

The shipping lane 208A may be a direct path, whereas the shipping lane 208B may include stops in one or more intermediate ports of call (not depicted), and transit through open sea as well as one or more waterways 212 that may be straits, locks, canals or other maritime zones that may be traffic controlled. For example, the depicted waterway 212 (e.g., the Strait of Malacca) is the busiest strait in the world, with tens of thousands of vessels per year passing through it. Shipwrecks, piracy and other catastrophic or delay-causing hazards are not uncommon in the Strait.

An exemplary historical data model may include a table including a plurality of shipments. Each of the shipments may include a shipment ID number (Shipment column) and may include a respective set of movement events between known locations. For example, with respect to the global shipping map 200, the historical data model may include shipments table (Table 1) having a schema and rows as follows:

| | Ship- | | | | |
|---|---|---|---|---|---|
| ID | ment | Event | Origin | Destination | Mode |
| 1 | 1 | Transit | Wuhan, CN | Shanghai, CN | Truck |
| 2 | 1 | Dwell | Shanghai, CN | Shanghai, CN | Container |
| | | | | | vessel |
| 3 | 1 | Transit | Shanghai, CN | Los Angeles, US | Container |
| | | | | | vessel |
| 4 | 1 | Dwell | Los Angeles, US | Los Angeles, US | Rail |
| 5 | 1 | Transit | Los Angeles, US | Chicago, US | Rail |
| 6 | 1 | Dwell | Chicago, US | Chicago, US | Rail |
| 7 | 1 | Transit | Chicago, US | Baltimore, US | Truck |

Table 1 may store a plurality of movement event rows, each having a respective event identifier (ID). Row ID 1 represents transit from a factory in Wuhan, CN (e.g., the origin 202A) to a first destination port (e.g., the port 204A) via a truck over the road 206A. The truck may travel on the road 206A, for example, to reach the port 204A. In some aspects, route information such as road route, air route and/or sea routes may be included in Table 1. Row ID 2 represents dwell at the first destination port (e.g., the port 204A) as the shipment is loaded onto a container vessel (mode column) on its way to a second destination port (e.g., the port 204B). Row ID 3 represents an event of transit from the first destination port to the second destination port via container vessel. Row ID 4 represents a dwell event as the shipment is loaded at the second destination port onto rail cars bound for a third destination port (e.g., the port 204D) via a rail network (e.g., via a series of rail lines including the rail line 210A). Row ID 5 represents an event of transit from the second destination port to the third destination port via rail. Row ID 6 represents a dwell event at the third destination as the shipment is offloaded from rail onto other rails cars (or there is other rail-related delay). And row 7 represents a transit event as the shipment is trucked from the third destination to the fourth destination.

In general, Table 1 may be stored in any suitable electronic database, such as the database 108 of FIG. 1. A flat file database or other suitable data structure storage mechanism may be used to store the information of Table 1, in some aspects. Timing information for each of the respective rows in Table 1 may be stored in a separate table (not depicted). In some aspects, an additional column may be included in Table 1 such that each row includes a respective time (e.g., dwell time for row ID 2 representing the amount of time taken to load the container vessel). Likewise, a separate table may include information regarding each truck and container vessel. Table 1 may include a separate column (not depicted) uniquely identifying each vessel and/or truck. Each of the rows above may include respective timing information.

The timing information may be expressed as absolute or relative times. For example, an absolute timestamp for each row enables the present techniques to compute a delay from each event row to the next. This timing information can be summed, for example, to learn the elapsed time from one event to any other. Other exemplary uses of this information are to calculate averages, for example, the average dwell time at any given port. Relative times may be expressed in a change in time, or delta from a prior entry. For example, a dwell time entry might be: +2 hours, 42 minutes, 5 seconds, 8 milliseconds and 3 microseconds, expressed as 2:42:5:8.3, wherein this is the time elapsed since the prior event for the shipment. For convenience in computation, these respective times may be expressed using epoch times (e.g., seconds from Jan. 1, 1970) or in any other suitable format.

The present techniques may include processing the information of Table 1 using a constructed electronic graph data structure. In general, graphs are mathematical structures used to model relations between objects. Graphs generally comprise one or more vertices (also referred to as nodes) and one or more edges (or links). Graphs may be directed or undirected, meaning that, as between two given nodes, traversal is permitted in only one direction, or in both directions.

A naive approach to the problem of modeling the data in Table 1 using a graph would be to assign nodes as locations (e.g., origins and destinations) and edges as events (e.g., transit, dwell, etc.). However, this approach would not allow the present techniques to distinguish between (and filter) events of different modes of transportation with respect to the same location. Thus, Table 1 may include a larger and richer set of data, in some aspects, and this richer data set may be used for modeling purposes.

For example, considering a given port (e.g., the port of Los Angeles), the characteristics of a dwell event between two ocean moves is distinct from a dwell event between an ocean move and a rail move. Thus, the present techniques must model, with respect to the same location, different forms of transport. Furthermore, the present techniques may need to model events (i.e., transitions) between facilities. For example, with respect to Table 1, prior to row ID 3, when the vessel arrives at Los Angeles, and prior to Row ID 5, when the cargo (e.g., containers) from the vessel depart to Chicago via rail, there may be inbound transit events from the origin port, a dwell event at the destination port, a transition such as a dray move from the destination port to a rail facility (e.g., a rail ramp), a dwell at the rail ramp and a transition from rail ramp to rail. Thus, each facility may distinguish between corresponding events of transportation and dray events.

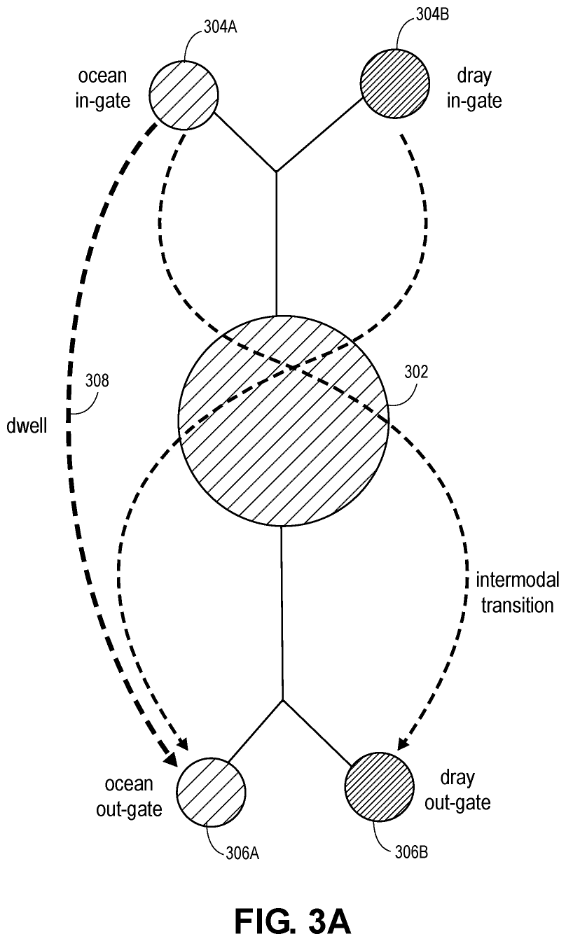

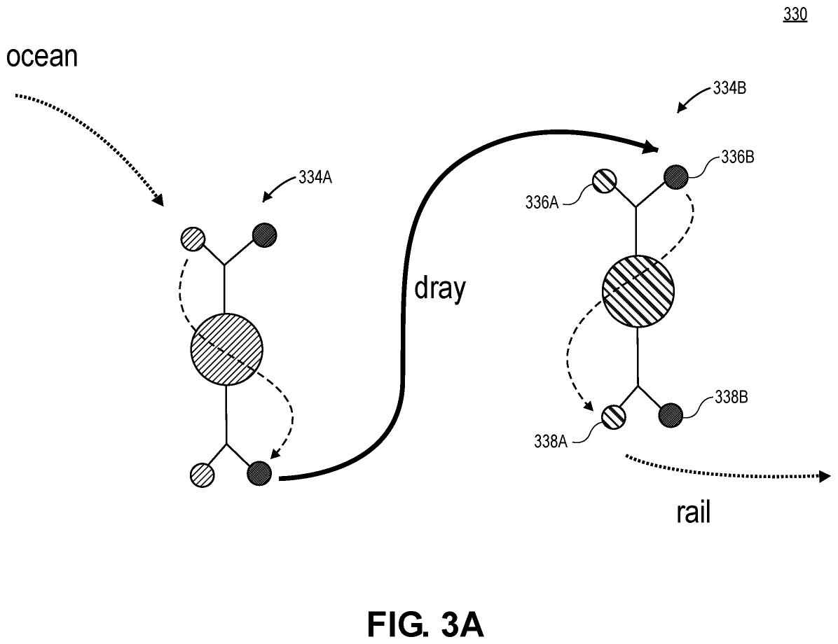

FIG. 3A depicts an exemplary graph representing a node 302 of a facility at a location (e.g., the port 204B), according to some aspects of the present techniques. The graph 300 conceptually represents the case where a container arrives via one mode (e.g., container vessel) and departs via another (e.g., rail). The node 302 may include, or to use graph theory terminology, be coupled to, an ocean in-gate node 304A and a dray in-gate node 304B (as discussed below, the node 302 may be coupled to a plurality of dray in-gate nodes, in-gate nodes, out-gate nodes, and/or corresponding edges).

The node 302 may also be coupled to an ocean out-gate node 306A and a dray out-gate node 306B. For example, a container may arrive at the facility via a container vessel and be offloaded at the ocean in-gate node 304A. In that case, the container may be conceptually modeled as transiting via the ocean in-gate node 304A. If the container is departing via an ocean vessel, then the container may transit to the ocean out-gate node 306A. In that case, the present techniques may model a dwell event 308. If the container is departing via a non-ocean mode (e.g., truck, rail, etc.) then the container may be conceptually modeled as transiting via the dray out-gate node 306B.

In another example, the container may arrive at the facility via a non-ocean mode (e.g., truck, rail, etc.) and be offloaded via the dray in-gate node 304B. If the container is departing via an ocean vessel, then the container may be conceptually modeled as transiting via the ocean out-gate node 306A.

Thus, FIG. 3A depicts a facility at a location, and a single mode of transportation (i.e., ocean cargo vessel). However, to properly model practical shipping realities, additional nodes and graphs are needed to represent additional transitions, as depicted in FIG. 3B.

FIG. 3B depicts an exemplary graph 330 depicting multiple modes of transportation represented as multiple subgraphs 334, according to some aspects of the present techniques. Specifically, the graph 330 depicts a node 334A that may correspond to the node 302 of FIG. 3A, and a node 334B that corresponds to a rail mode of transport.

As in FIG. 3A, the node 334A of FIG. 3B inputs containers via an ocean in-gate or via a dray in-gate, and outputs the containers via an ocean out-gate or via a dray out-gate. For example, FIG. 3B depicts containers output via the dray out-gate of the node 334A and input to a dray in-gate 336B of the second node 334B. The node 334B also includes a rail in-gate 336A that containers that arrive by rail may be input into, in some aspects.

The node 334B may include a rail out-gate 338A that may be used when containers that arrive via the dray in-gate 336B are departing via rail, as depicted in the case of FIG. 3B, and a dray out-gate 338B that may be used to conceptually transit a container from the rail in-gate 336A to another mode of transport (e.g., truck, air, ocean, etc.). The present techniques may model rail dwell time for containers that are input via the rail in-gate 336A and output via the rail out-gate 338A.

In general, the data structures of FIG. 3A and FIG. 3B enable the transit of any container to be modeled, including dwell time, and even when the container includes one or more intermodal transition. Each location (e.g., port, railyard, airport, etc.) may be represented by an individual graph that includes mode-specific facilities having a number (e.g., four) of gates representing inputs and outputs, wherein at least one of the inputs is a dray in-gate and at least one of the outputs is a dray out-gate.

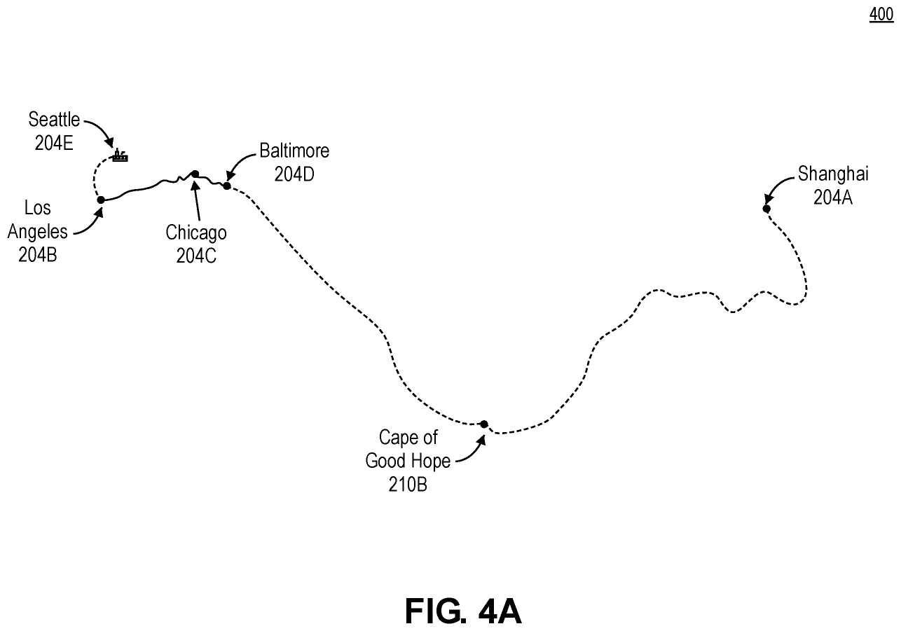

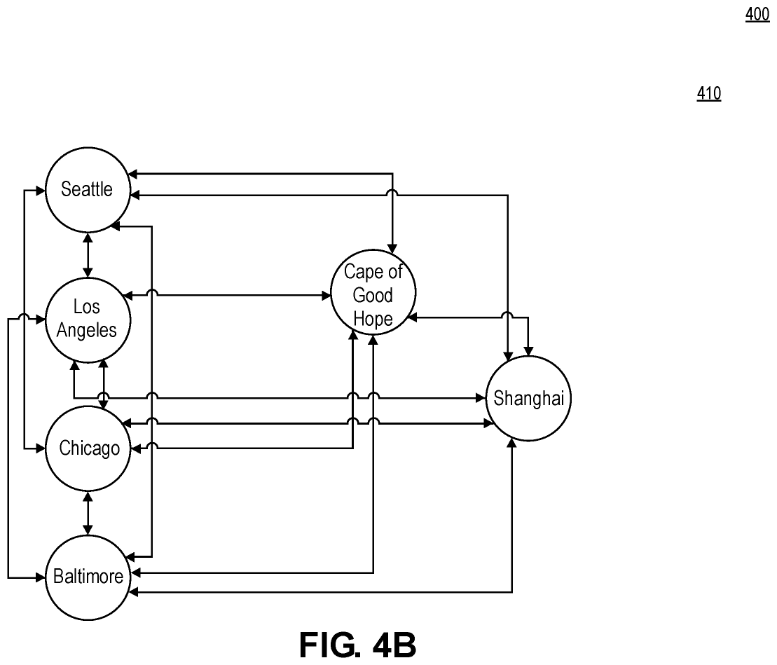

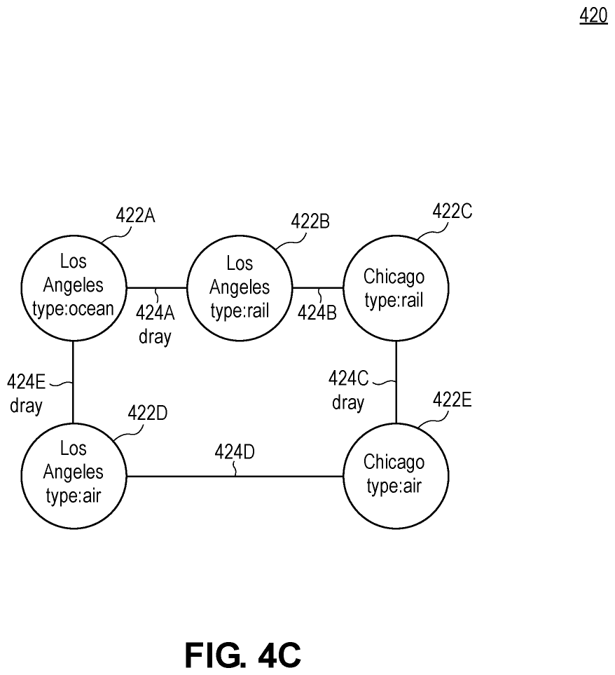

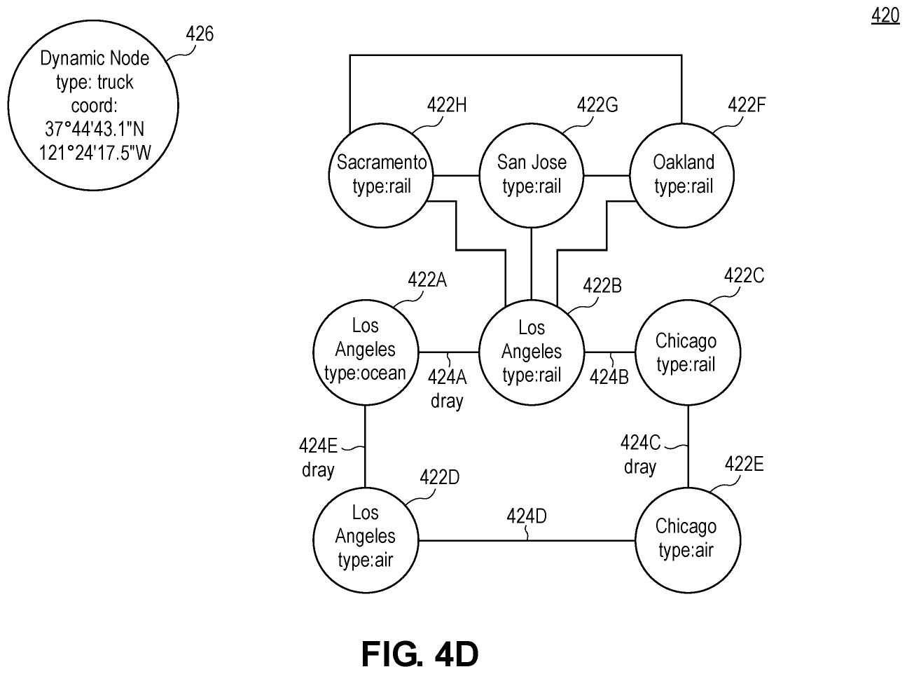

Returning to the global shipping map 200, FIG. 4A depicts a graph 400 of the shipment routes and known locations of the global shipping map 200, according to some aspects. FIG. 4B depicts a graph 410 of all of potential connections (edges) between the locations in the global shipping map 200, according to some aspects. It should be appreciated that FIG. 4B illustrates why a mere graph is insufficient to model shipments; among other things, the graph 410 does not differentiate between different modes of transportation.

FIG. 4C depicts a graph 420 that includes a plurality of location nodes 422 and a plurality of transit edges 424. With respect to the graph 420, the location node 422A corresponds to the Los Angeles ocean port, at which ocean vessels arrive and depart. The location node 422B corresponds to the Los Angeles rail yard. As shown the location node 422A is connected to the location node 422B by a dray transit edge 424A. In a graph constructed by the present techniques, dray transit edges are those that are limited to dray traffic (e.g., moving container cargo from an ocean vessel to a rail ramp, or vice versa, or other intermodal transfers). Dray edge types enable real-world transit constraints to be modeled. The graph 4C also includes a transit edge 424B connecting node 422B to 422C, which in practice, means that these two nodes can reach one another via rail. Node 422C is connected to a local node 422E via a dray edge 424C, and node 422E is connected to node 422D by a transit edge 424D. Returning to node 422A, it is connected to the node 422D (Los Angeles airport) by a second dray edge 424E.

The example of FIG. 3 is merely for illustration purposes. In practice, the graph may include many (e.g., one million or more) nodes, and orders of magnitudes more edges. Further, there may be additional segments connecting two given nodes. For example, the node 422C may include multiple dray nodes, representing different rail ramps each of which service the rail yard at node 422C. The same potential proliferation of edges may apply to the other nodes depicted in FIG. 4C, and to other nodes that are not included in FIG. 4C.

As shown above, rail, air and ocean may each have consistent, finite sets of known locations (i.e., ports, airports, railyards) that the present techniques can model in terms of inputs and outputs, whether via dray or mode of travel.

However, the same consistency does not hold for over-the-road transit (i.e., trucking). For example, a truck can move goods between any two known locations, and any other location including retail stores, distribution centers, or any other place accessible by road. The present techniques advantageously provide the ability to model such transit aspects by adding modeling of dynamic (e.g., over-the-road transit) locations to the modeling of static transit locations like airports, seaports and railyards.

For example, over-the-road trucks often transport cargo (e.g., shipping containers) to/from the location types already identified (e.g., airports, rail yards, ocean vessels and sea ports, etc.) to buildings such as distribution centers or retail locations. The location of a distribution center impacts the amount of time it takes goods to get there.

To model truck transit, start and end nodes may be dynamically added to the graph. Next, two general cases may be addressed. The first case occurs when the location (e.g., latitude and longitude coordinates) of a truck origin or destination is a known location (e.g., the node 422E of the FIG. 4D). In that case, the present techniques may “snap” the truck origin or destination to the known destination, effectively treating that location as the location of the truck for modeling purposes. The graph may be algorithmically processed (e.g., using traversal or iteration) processing the truck nodes as though they are static location nodes.

In the second case, wherein the start and/or end nodes do not match a known node location, the present techniques dynamically add an edge to all known nodes within a pre-determined (and configurable) distance radius and estimate the transit time from the start/end node to each of the connected nodes. This modeling may be performed using a separate truckload model, in some aspects, as shown in FIG. 4D.

FIG. 4D depicts an example of adding truckload modeling to the graph 420 of FIG. 4C, according to some aspects. For example, with reference to FIG. 2, if a user wants an estimate for a shipment from a Los Angeles-area distribution center to a port in China, a method may include receiving start latitude and longitude coordinates (e.g., via the computing device 115 and/or the server 109 of FIG. 1) for the start location in the Los Angeles area. The method may include determining that the start location is not specifically located at any of the locations of the location nodes 422 (i.e., the locations about which the graph already has location information). The method may include creating a dynamic start node at the provided latitude and longitude coordinates, as shown in a dynamic node 426 of FIG. 4D. For example, the provided coordinates may be 39° 44′43.1″N 121° 24′17.5″W, near Stockton, Modesto and Fremont, California. The method may include locating one or more candidate nodes in the graph 420 (e.g., the nodes 422F, 422G and 422H representing, in this example, Oakland, San Jose and Sacramento rail terminals).

For example, the method may select these proximal nodes given their proximity to a departure port (Los Angeles). In some aspects, more/fewer nodes may be selected. In some aspects, nodes may be selected based on criteria other than proximity. The method may include dynamically connecting the dynamic node 426 to one or more of the nodes 422 of the graph 420, including the nodes 422A, 422B, 422D, 422F, 422G, and 422H, for example. These nodes may be selected for dynamic connection on the basis of their proximity to the dynamic node 426, for example. The method may include solving the distance between the dynamic node 426 and each of the connected nodes, solving the graph as discussed above, to determine a solution for transit from the dynamic node 426 to each of the respective candidate nodes. The method may include choosing the best solution as discussed above. The method may include cleaning up (i.e., removing) the dynamically generated node(s) (e.g., the dynamic node 426) and any dynamic connections from the dynamically generated node(s) to other nodes. It should be appreciated that the example of FIG. 4D is for discussion purposes and that in practice, the graph 420 may include many more (e.g., thousands, millions, or more) of dynamic nodes and dynamic connections.

In another example of dynamic truck modeling, a shipment may arrive at an airport (e.g., the airport node 422E of FIG. 4D). The present techniques may then dynamically connect the airport to all distribution centers within a given proximity (e.g., one or more distribution centers within 100 kilometers). The time to reach each of the distribution centers/warehouses may be computed.

One or more specific models may be used in the present techniques. In some aspects, one or more machine learning models (e.g., one or more supervised/unsupervised machine learning models) may be trained using historical data to make predictions. In some aspects, all historical data may be used for training, whereas in other aspects only a subset of historical data may be used (e.g., data from the prior three months, seasonal data, etc.) and/or excluding certain portions of training data. Limiting data may be advantageous, given that supply disruptions may skew training data sets. For example, anecdotal testing has shown that some data sets (e.g., data collected during the SARS-COV-2 pandemic, or during the time that the Ever Given was aground in the Suez canal) may not be representative.

One or more graph optimization models may be trained. The graphs discussed herein (e.g., the graph 300, the graph 400, the graph 410, the graph 420, etc.) may be used in conjunction with such graph optimization models. In some aspects, the graph optimization models may be implemented using a modified bidirectional Dijkstra's algorithm. For example, as depicted in FIG. 4D, the graph 420 may include a plurality of locations (nodes), and one or more an entry points (e.g., in-gate) and exit points (e.g., out-gate) may be modeled, and/or one or more dwell events. Aspects of the graph may be directional, insofar as that some edges between nodes may be used to represent dwells and intermodal transitions, as shown in FIG. 3A, for example. Optimization algorithms such as Dijkstra's may be used to find the best path(s) between two locations, including constraints/optimization parameters as discussed above. In some aspects, an optimized metric may include both transit duration and the likelihood of taking any given path. The combination of these two metrics may be used to implement a modified Dijkstra's traversal.

As discussed, the present techniques provide graphs that include information on multimodal travel, such as modes that are tracked by a transportation/logistics company (e.g., ocean, over the road, trucking, air, rail, etc.). The present techniques enable modeling of movement of items (e.g., containers) between multiple locations, via a sequence of moving and stopping events (e.g., transits and dwells) that are tied together as a journey. The present techniques enable data to be combined from different modes, and for historical data to be used to predict a number of different aspects about cargo transportation, such as (1) the amount of time it will take to transit from an origin point to a destination point and (2) how long it will take to transition from arriving at a location to another (the length of any given dwell).

Furthermore, because the travel time of each segment along the route can be determined, estimations based on historical data may be combined, to predict, for any given shipment from an origin to a destination, how long it will take to traverse from the origin to the destination, given the net cost of transit at every point along the way. In this manner, the best route may also be determined.

The present techniques may receive input parameters that specify a proposed shipment (e.g., origin location, destination location, one or more specific routes including respective modes of travel for those routes, waypoints, etc.). Generally, the more input information provided to the present techniques (e.g., via the customer) the better the present techniques will be at providing useful estimates/options. For example, if the input parameters include only an origin (e.g., Shanghai) and a destination (e.g., Los Angeles) the present techniques may perform an exhaustive search of many (e.g., hundreds, thousands or more) of possible routes between the two locations, to provide estimations of different possible paths between the two locations, the respective total travel time of the different paths, and the travel time of one or more segments within the respective paths.

In some aspects, one or more adjustable optimization metric may be selected to provide estimations, such as overall speed, overall cost, overall emissions, and/or combinations thereof. Further in some aspects, one or more constraints may be used to control the output of the modeling, such as mode (e.g., preferring rail to air), specific routes (e.g., preferring Pacific Ocean vessel routes to Atlantic Ocean vessel routes), including/avoiding certain waypoints, using certain carriers (e.g., when the customer has a contract or discount), specific modes (e.g., truck and rail only) etc.

Still further, different optimization metrics may be used in some aspects of the present techniques. In fact, any suitable optimization metric(s) that can be derived from distance-based metrics and/or historical transit times may be used as an optimization metric. Metric profiles may be used. For example, metrics may be based on the identity of the customer or user of the technique. For example, a common carrier customer using the present techniques may provide a set of optimization metrics that are unique to the common carrier industry, and/or to that specific common carrier. On the other hand, a retailer using the present techniques may use a set of standardized retailer optimization metrics, and/or metrics that are customized for that particular retailer.

The provision of historical data enables the above-described optimization/constraints, in advantageous improvements over conventional techniques. As noted, because the shipping industry is global, no one party knows all of the information in the system at any given time. For example, regarding optimizing for a specific carrier, no one party knows which carriers are available along any given route including all of the segments of that route. As discussed, the present techniques are able to analyze historical data to make educated guesses regarding route information (e.g., which carriers historically served a given route or segment). Thus, the present techniques are able to enrich routes and segments within graphs, and to integrate that data into predictions as optimization constraints and/or optimization metrics.

The present techniques offer an improvement to a technology/technical field, in particular that of shipping time estimate software used in global logistics. For example, faster processing is provided by the present graph-based techniques, which are designed to work with the large datasets generated by global shipping firms. This means that shipping estimates can be generated more quickly, allowing logistics companies and their customers to make more informed decisions about how to route shipments. The present graph-based techniques also apply relationships between data to make more accurate predictions. By training a graph to optimize for various criteria, the present techniques are able to identify efficient routes, taking into consideration the preferences of the customer and different factors including cost, environmental impact, etc. This leads to improved efficiency and reduced cost not only for the shipper, but for the logistics network as a whole, by reducing overall resource consumption. The present graph-based techniques are also highly scalable, meaning they can handle larger datasets especially those that include many different nodes or locations. The present graph-based techniques are also more performant than other implementations, because they leverage the inherent structure of graphs to enable optimization to be computed much more quickly. Other benefits of the present techniques include more flexibility over traditional optimization techniques; specifically, the incorporation different data types, and the ability to train for constraints and objectives.

In some aspects, the input parameters may include one or more specific route segments (e.g., one or more routes selected by a customer). For example, a customer may specify that a given shipment will be trucked from an origin to a specific port location (e.g., from 202A to 204B), then shipped via ocean vessel (e.g., from 204A to the port 204D), the loaded onto rail for transit to 204C to a distribution center (e.g., 202B) via truck. In this case, the present techniques may traverse only the subset of the graph involving the specific routes included in the provided input parameters, to provide timing estimates for each of the provided segments. For example, the dwell time (e.g., number of days the shipment will sit idle) and transit times may be estimated for each respective segment of the overall route. The present techniques may output an overall transit time, given the net transit and dwell times.

As discussed above, the present techniques may be used to provide customers with estimates of multimodal shipping times that are far and above anything currently available in the global shipping industry, in terms of accuracy of predictions based on historical data.

For example, in an aspect, a customer may be tracking a shipment with a shipping and logistics company. The customer may provide input parameters of: origin=Shanghai, destination=Chicago. The customer may have a pre-determined route for the shipment in mind. However, this customer may simply provide minimal origin and destination parameters to confirm that the customer's pre-determined route is, in fact, the best route to take. The customer may modify optimization parameters (e.g., cost, emissions, time) to see whether the predicted best route changes. The present techniques may display a graphical user interface (e.g., based on the map 200 of FIG. 2) to provide the customer with a visual depiction of the predicted best route. For example, the present techniques may predict that the shipment will take 60 days via the fastest route.

In another example, the customer may need help in selecting a carrier. The present techniques may include a user interface enabling the customer to select one or more constraints. In this case, rather than (or in addition to) predicting the total time of the shipment, the present techniques may provide the customer with multiple times of transit, comparing reliability and time between the multiple carriers. The customer may interactively choose one or more carriers for different segments of a given route/journey.

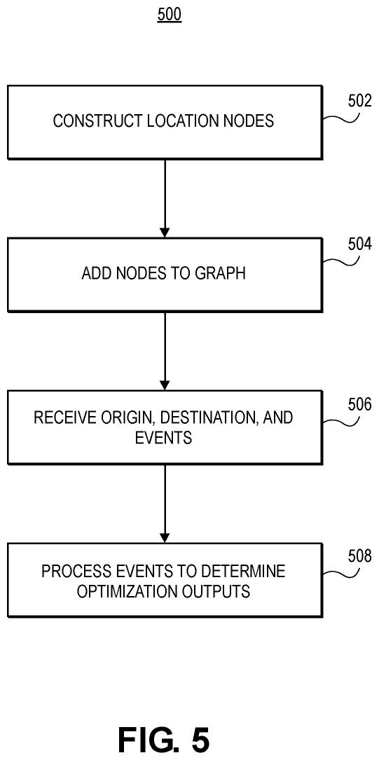

FIG. 5 depicts a block diagram of an example method 500 of using machine learning to construct and train a graph to determine target outcomes corresponding to a cargo shipment. The method may be performed by the components of FIG. 1, for example.

The method 500 may include constructing, via one or more processors, a plurality of location nodes, wherein each of the location nodes corresponds to a respective location type, wherein each of the location nodes corresponds to a respective real-world location, and wherein each of the location includes a mode input, a dray input, a mode output, and a dray output (block 502). Each respective location type may be selected from the group consisting of (i) seaport, (ii) railyard and (iii) airport.

The method 500 may include adding, via one or more processors, the plurality of location nodes to the graph (block 504).

The method 500 may include receiving, via one or more processors, an origin input parameter, a destination input parameter, and one or more shipment events corresponding to the cargo shipment; and (block 506). The one or more events may include at least one of (i) a transit event, (ii) a dwell event or (iii) a dray event.

The method 500 may include processing, via one or more processors, the events using the graph to determine one or more target outcomes corresponding to the cargo shipment. (block 508). The target outcomes include at least one of (i) a net transit time of the cargo shipment, (ii) a net transit cost of the cargo shipment, (iii) a net emissions measure of the cargo shipment. Processing the events using the graph to determine one or more target outcomes corresponding to the cargo shipment may training include, via one or more processors, a machine learning model using historical data to predict information related to at least one segment of the cargo shipment. The cargo shipment may include at least one trucking segment, and processing, via one or more processors, the events using the graph to determine one or more target outcomes corresponding to the cargo shipment may include dynamically generating a node representing origin of the trucking segment; adding the dynamically-generated node to the graph;
selecting one or more candidate nodes; and/or dynamically connecting the dynamically-generated node to each of the one or more candidate nodes. Processing, via one or more processors, the events using the graph to determine one or more target outcomes corresponding to the cargo shipment may include determining the one or more target outcomes based on one or more optimization metrics and/or one or more optimization constraints.

As discussed above, the present techniques include both training and inference phases. The various target outputs, or graph optimization outputs, may be computed for each edge of the graph (during training) before running inference. In other words, during the training phase, the weights of graph nodes may be established, such that when new inputs are supplied to the graph, it is to make predictions based on those weights without additional training. In some aspects, additional training (e.g., fine tuning) may be performed to improve graph-based predictions.

Although the following text sets forth a detailed description of numerous different aspects, it should be understood that the legal scope of the invention may be defined by the words of the claims set forth at the end of this patent. The detailed description is to be construed as exemplary only and does not describe every possible aspect, as describing every possible aspect would be impractical, if not impossible. One could implement numerous alternate aspects, using either current technology or technology developed after the filing date of this patent, which would still fall within the scope of the claims.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein.

Additionally, certain aspects are described herein as including logic or a number of routines, subroutines, applications, or instructions. These may constitute either software (e.g., code embodied on a non-transitory, machine-readable medium) or hardware. In hardware, the routines, etc., are tangible units capable of performing certain operations and may be configured or arranged in a certain manner. In example aspects, one or more computer systems (e.g., a standalone, client or server computer system) or one or more hardware modules of a computer system (e.g., a processor or a group of processors) may be configured by software (e.g., an application or application portion) as a hardware module that operates to perform certain operations as described herein.

In various aspects, a hardware module may be implemented mechanically or electronically. For example, a hardware module may comprise dedicated circuitry or logic that may be permanently configured (e.g., as a special-purpose processor, such as a field programmable gate array (FPGA) or an application-specific integrated circuit (ASIC)) to perform certain operations. A hardware module may also comprise programmable logic or circuitry (e.g., as encompassed within a general-purpose processor or other programmable processor) that may be temporarily configured by software to perform certain operations. It will be appreciated that the decision to implement a hardware module mechanically, in dedicated and permanently configured circuitry, or in temporarily configured circuitry (e.g., configured by software) may be driven by cost and time considerations.

Accordingly, the term “hardware module” should be understood to encompass a tangible entity, be that an entity that is physically constructed, permanently configured (e.g., hardwired), or temporarily configured (e.g., programmed) to operate in a certain manner or to perform certain operations described herein. Considering aspects in which hardware modules are temporarily configured (e.g., programmed), each of the hardware modules need not be configured or instantiated at any one instance in time. For example, where the hardware modules comprise a general-purpose processor configured using software, the general-purpose processor may be configured as respective different hardware modules at different times. Software may accordingly configure a processor, for example, to constitute a particular hardware module at one instance of time and to constitute a different hardware module at a different instance of time.

Hardware modules may provide information to, and receive information from, other hardware modules. Accordingly, the described hardware modules may be regarded as being communicatively coupled. Where multiple of such hardware modules exist contemporaneously, communications may be achieved through signal transmission (e.g., over appropriate circuits and buses) that connect the hardware modules. In aspects in which multiple hardware modules are configured or instantiated at different times, communications between such hardware modules may be achieved, for example, through the storage and retrieval of information in memory structures to which the multiple hardware modules have access. For example, one hardware module may perform an operation and store the output of that operation in a memory device to which it may be communicatively coupled. A further hardware module may then, at a later time, access the memory device to retrieve and process the stored output. Hardware modules may also initiate communications with input or output devices, and may operate on a resource (e.g., a collection of information).

The various operations of example methods described herein may be performed, at least partially, by one or more processors that are temporarily configured (e.g., by software) or permanently configured to perform the relevant operations. Whether temporarily or permanently configured, such processors may constitute processor-implemented modules that operate to perform one or more operations or functions. The modules referred to herein may, in some example aspects, comprise processor-implemented modules.

Similarly, the methods or routines described herein may be at least partially processor-implemented. For example, at least some of the operations of a method may be performed by one or more processors or processor-implemented hardware modules. The performance of certain of the operations may be distributed among the one or more processors, not only residing within a single machine, but deployed across a number of machines. In some example aspects, the processor or processors may be located in a single location (e.g., within a home environment, an office environment, or as a server farm), while in other aspects the processors may be distributed across a number of locations.

The performance of certain of the operations may be distributed among the one or more processors, not only residing within a single machine, but deployed across a number of machines. In some example aspects, the one or more processors or processor-implemented modules may be located in a single geographic location (e.g., within a home environment, an office environment, or a server farm). In other example aspects, the one or more processors or processor-implemented modules may be distributed across a number of geographic locations.

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one aspect” or “an aspect” means that a particular element, feature, structure, or characteristic described in connection with the aspect may be included in at least one aspect. The appearances of the phrase “in one aspect” in various places in the specification are not necessarily all referring to the same aspect.

As used herein, the terms “comprises,” “comprising,” “may include,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of the “a” or “an” are employed to describe elements and components of the aspects herein. This is done merely for convenience and to give a general sense of the description. This description, and the claims that follow, should be read to include one or at least one and the singular also may include the plural unless it is obvious that it is meant otherwise.

This detailed description is to be construed as examples and does not describe every possible aspect, as describing every possible aspect would be impractical.

What is claimed is:

1. A computer-implemented method of using machine learning to construct and train a graph to predict target outcomes corresponding to a cargo shipment, the method comprising:
constructing, via one or more processors, a plurality of location nodes, wherein each of the location nodes corresponds to a respective location type,
wherein each of the location nodes corresponds to a respective real-world location, and
wherein each of the location nodes includes a mode input, a dray input, a mode output, and a dray output;
adding, via one or more processors, the plurality of location nodes to the graph;
receiving, via one or more processors, an origin input parameter, a destination input parameter, and one or more shipment events corresponding to the cargo shipment; and
processing, via one or more processors, the shipment events using the graph to determine one or more target outcomes corresponding to the cargo shipment.

2. The computer-implemented method of claim 1,
wherein each respective location type is selected from the group consisting of (i) seaport, (ii) railyard and (iii) airport.

3. The computer-implemented method of claim 1,
wherein the one or more shipment events include at least one of (i) a transit event, (ii) a dwell event or (iii) a dray event.

4. The computer-implemented method of claim 1,
wherein the target outcomes include at least one of (i) a net transit time of the cargo shipment, (ii) a net transit cost of the cargo shipment, (iii) a net emissions measure of the cargo shipment.

5. The computer-implemented method of claim 1,
wherein processing the events using the graph to determine one or more target outcomes corresponding to the cargo shipment includes:
training, via one or more processors, a machine learning model using historical data to predict information related to at least one segment of the cargo shipment.

6. The computer-implement method of claim 1,
wherein the cargo shipment includes at least one trucking segment, and
wherein processing, via one or more processors, the events using the graph to determine one or more target outcomes corresponding to the cargo shipment includes:
dynamically generating a node representing an origin of the trucking segment;
adding the dynamically-generated node to the graph;
selecting one or more candidate nodes; and
dynamically connecting the dynamically-generated node to each of the one or more candidate nodes.

7. The computer-implemented method of claim 1,
wherein processing, via one or more processors, the events using the graph to determine one or more target outcomes corresponding to the cargo shipment includes:
determining the one or more target outcomes based on one or more optimization metrics and/or one or more optimization constraints.

8. A computing system for using machine learning to construct and train a graph to predict target outcomes corresponding to a cargo shipment, comprising:
one or more processors; and
one or more memories having stored thereon computer-executable instructions that, when executed by the one or more processors, cause the computing system to:
construct a plurality of location nodes, wherein each of the location nodes corresponds to a respective location type,
wherein each of the location nodes corresponds to a respective real-world location, and
wherein each of the location nodes includes a mode input, a dray input, a mode output, and a dray output;
add the plurality of location nodes to the graph;
receive an origin input parameter, a destination input parameter, and one or more shipment events corresponding to the cargo shipment; and
process, via one or more processors, the shipment events using the graph to determine one or more target outcomes corresponding to the cargo shipment.

9. The computing system of claim 8, the one or more memories having stored thereon further instructions that, when executed by the one or more processors, cause the computing system to:
select each respective location type from the group consisting of (i) seaport, (ii) railyard and (iii) airport.

10. The computing system of claim 8,
wherein the one or more shipment events include at least one of (i) a transit event, (ii) a dwell event or (iii) a dray event.

11. The computing system of claim 8,
wherein the target outcomes include at least one of (i) a net transit time of the cargo shipment, (ii) a net transit cost of the cargo shipment, (iii) a net emissions measure of the cargo shipment.

12. The computing system of claim 8, the one or more memories having stored thereon further instructions that, when executed by the one or more processors, cause the computing system to:
train a machine learning model using historical data to predict information related to at least one segment of the cargo shipment.

13. The computing system of claim 8, the one or more memories having stored thereon further instructions that, when executed by the one or more processors, cause the computing system to:
dynamically generate a node representing an origin of a trucking segment;
add the dynamically-generated node to the graph;
select one or more candidate nodes; and
dynamically connect the dynamically-generated node to each of the one or more candidate nodes.

14. The computing system of claim 8, the one or more memories having stored thereon further instructions that, when executed by the one or more processors, cause the computing system to:
determine the one or more target outcomes based on one or more optimization metrics and/or one or more optimization constraints.

15. A computer-readable medium having stored thereon a set of instructions that, when executed by one or more processors, cause a computer to:
construct a plurality of location nodes, wherein each of the location nodes corresponds to a respective location type,
wherein each of the location nodes corresponds to a respective real-world location, and
wherein each of the location nodes includes a mode input, a dray input, a mode output, and a dray output;
add the plurality of location nodes to the graph;
receive an origin input parameter, a destination input parameter, and one or more shipment events corresponding to the cargo shipment; and
process, via one or more processors, the shipment events using the graph to determine one or more target outcomes corresponding to the cargo shipment.

16. The computer-readable medium of claim 15, the one or more memories having stored thereon instructions that, when executed by the one or more processors, cause a computer to:
select each respective location type from the group consisting of (i) seaport, (ii) railyard and (iii) airport.

17. The computer-readable medium of claim 15, the one or more memories having stored thereon instructions that, when executed by the one or more processors, cause a computer to:
wherein the one or more shipment events include at least one of (i) a transit event, (ii) a dwell event or (iii) a dray event.

18. The computer-readable medium of claim 15, the one or more memories having stored thereon instructions that, when executed by the one or more processors, cause a computer to:
train a machine learning model using historical data to predict information related to at least one segment of the cargo shipment.

19. The computer-readable medium of claim 15, the one or more memories having stored thereon instructions that, when executed by the one or more processors, cause a computer to:
dynamically generate a node representing an origin of a trucking segment;
add the dynamically-generated node to the graph;
select one or more candidate nodes; and
dynamically connect the dynamically-generated node to each of the one or more candidate nodes.

20. The computer-readable medium of claim 15, the one or more memories having stored thereon instructions that, when executed by the one or more processors, cause a computer to:
determine the one or more target outcomes based on one or more optimization metrics and/or one or more optimization constraints.
